(19) United States
(12) Patent Application Publication
(10) Pub. No.: US 2012/0272919 A1
(43) Pub. Date: Nov. 1, 2012

(54) ANIMAL EUTHANASIA SYSTEMS AND METHODS

(75) Inventor: William J. M. McClelland, Salt Lake City, UT (US)

(73) Assignee: THE UNIVERSITY OF UTAH, Salt Lake City, UT (US)

(21) Appl. No.: 13/094,792

(22) Filed: Apr. 26, 2011

(51) Int. Cl. A01K 1/03

(52) U.S. Cl. 119/420

(57) ABSTRACT

An example system for euthanizing animals disclosed herein includes an animal housing having an opening configured to receive euthanizing gas and a valve configured to increase an amount of the euthanizing gas supplied to the animal housing through the opening in response to the animal housing being placed in a predetermined position with respect to the valve. An example method for euthanizing animals disclosed herein includes providing a liquid source to an animal housed in an animal housing through an opening in the animal housing and supplying a euthanizing gas to the animal through the opening to euthanize the animal.

### BACKGROUND

The present invention relates to animal euthanasia systems and methods and more particularly to animal euthanasia systems and methods with improved convenience and versatility of use.

Animal euthanasia systems typically expose animals to be euthanized to a euthanizing gas, such as carbon dioxide, to humanely dispose of the animals. Such euthanasia systems are frequently used to meet the needs of a laboratory in which experiments are performed on animals, such as mice, rats, or other rodents. After the experiments are completed the animals are euthanized.

Current animal euthanasia systems suffer various drawbacks. For example, certain systems accommodate only a small number of animals at a time. Moreover, although some systems have a large number of stations that can accommodate a corresponding large number of animal housings or cages, each station must be occupied by a corresponding animal housing to ensure safe operation. If even one station is not occupied by an animal housing during operation of such systems, the surrounding environment is exposed to euthanizing gas, which is harmful to human operators.

Leakage of euthanizing gas is another drawback of many of the existing animal euthanasia systems. More particularly, current euthanasia systems supply euthanizing gas into an animal housing via a perforated lid of the animal housing. This indirect method of supplying the euthanizing gas causes a substantial portion of the gas to be introduced into the surrounding environment. Various techniques have been devised to address this drawback. For example, one current system includes a vacuum to vacuum any euthanizing gas that is leaked into the environment. However, a vacuum undesirably introduces other drawbacks to the system, such as energy costs, noise, and bulk.

Another technique that addresses leakage of euthanizing gas is to mix euthanizing gas with another non-euthanizing gas. However, this technique increases processing time and adds bulk to the euthanizing system, which reduces or even precludes mobility of the system.

### SUMMARY

In general, embodiments of the proposed invention relate to methods and systems for euthanizing animals quickly, efficiently, and safely. Example animal euthanasia systems permit small or large numbers of animals to be euthanized at the same time. Moreover, example systems can accept a variety of animal housing sizes and, in certain embodiments, may reduce processing time by introducing a euthanizing gas into the animal housings directly without mixing.

A first general aspect of the invention is a system for euthanizing animals that includes: a first animal housing having an opening configured to receive euthanizing gas, and a first valve configured to increase an amount of the euthanizing gas supplied to the first animal housing through the opening in response to the first animal housing being placed in a predetermined position with respect to the first valve.

In another embodiment, the first valve of the system for euthanizing animals is a poppet valve. The poppet valve may be configured to increase the amount of euthanizing gas by opening in response to the first animal housing being pressed against the poppet valve.

In another embodiment, a nose portion of the first valve of the system for euthanizing animals is configured to fit within the opening of the first animal housing. Moreover, a portion of the first animal housing that surrounds the opening may be configured to abut a shoulder of the first valve that surrounds the nose portion thereof. The first valve may be configured to increase the amount of the euthanizing gas supplied to the first animal housing through the opening in response to pressure applied by the first animal housing to the shoulder of the first valve.

In another embodiment, the system for euthanizing animals further includes a euthanizing gas supply in fluid communication with the first valve.

In another embodiment, the system for euthanizing animals further includes a second animal housing having an opening configured to receive euthanizing gas, and a second valve configured to increase an amount of the euthanizing gas supplied to the second animal housing through the opening of the second animal housing in response to the second animal housing being placed in a predetermined position with respect to the second valve.

In another embodiment, the system for euthanizing animals further includes a rack configured to physically support the first animal housing and to maintain the first animal housing in the predetermined position.

A second general aspect of the invention is a method for euthanizing animals, the method including: providing a liquid source to an animal housed in an animal housing through an opening in the animal housing, and supplying a euthanizing gas to the animal through the opening to euthanize the animal.

In one embodiment, providing the liquid source includes passing a feeding valve that is in fluid communication with a liquid supply through the opening.

In another embodiment, supplying the euthanizing gas includes passing at least a portion of a euthanizing gas valve that is in fluid communication with a euthanizing gas supply through the opening in the animal housing. The euthanizing gas valve may automatically open in response to the at least a portion of the euthanizing gas valve being passed through the opening.

In another embodiment, the animal housing includes a hinged door that covers the opening and the method further includes inserting a door opener in the opening to maintain the hinged door in an open configuration prior to providing the liquid source through the opening. The door opener may be shaped and configured to physically support the feeding valve. In addition, the door opener may be configured to mate with the feeding valve in an interference fit and may be configured to mate with the opening in an interference fit. Alternatively, instead of inserting a door opener, a feeding valve and/or a tube in fluid communication with a liquid supply may be configured to maintain the hinged door in an open configuration.

A third general aspect of the invention is a system for euthanizing animals, the system including: a rack having a plurality of stations configured to accommodate a plurality of animal housings, and a plurality of detectors corresponding to the plurality of stations, each detector being configured to detect when the corresponding station is occupied by an animal housing.

In one embodiment, the each of the detectors includes a valve configured to supply euthanizing gas to the animal housing accommodated by the corresponding station in response to the detector detecting the animal housing.

In another embodiment, if fewer than all of the stations are occupied by a corresponding animal housing, the system is configured to supply euthanizing gas to only the stations at which the plurality of detectors detect an animal housing.

In another embodiment, the rack includes a framing structure configured to physically support the plurality of animal housings accommodated at each station, and at least a portion of the framing structure is further configured to convey euthanizing gas from a euthanizing gas supply to a valve at each station. The detector at each station may include the corresponding valve.

A fourth general aspect of the invention is a method for euthanizing animals, the method including using a first poppet valve to supply euthanizing gas into a first animal housing.

In one embodiment, the method further includes using a second poppet valve to supply euthanizing gas into a second animal housing, the first and second poppet valves being in fluid communication with each other and with a euthanizing gas supply.

In another embodiment, using the first poppet valve to supply euthanizing gas into the first animal housing includes: coupling the first poppet valve to a euthanizing gas supply, positioning an outlet port of the first poppet valve into an opening in the first animal housing, and pressing the first animal housing against the first poppet valve to open the first poppet valve.

Additional features of the invention will be set forth in the description which follows, and in part will be obvious from the description, or may be learned by the practice of the invention. The features of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 shows an example animal euthanasia system including a rack;

FIG. 2 shows an exterior view of an example animal housing for use in the animal euthanasia system of FIG. 1;

FIG. 2 shows an interior view of the example animal housing of FIG. 2;

FIG. 4 shows a front view of a door opener for use with the animal housing of FIGS. 2 and 3;

FIG. 5 shows a back view of the door opener of FIG. 4;

FIG. 6 shows a side view of the door opener of FIG. 4;

FIG. 7 shows a first position of the animal housing of FIGS. 2 and 3 during a euthanasia phase of operation;

FIG. 8 shows a second position of the animal housing of FIGS. 2 and 3 during a euthanasia phase of operation;

FIG. 9 shows a first example method for euthanizing animals; and

FIG. 10 shows a second example method for euthanizing animals.

### DETAILED DESCRIPTION

Reference will now be made to the figures wherein like structures will be provided with like reference designations. It is understood that the figures are diagrammatic and schematic representations of presently preferred embodiments of the invention, and are not limiting of the present invention, nor are they necessarily drawn to scale.

Embodiments of systems and methods described herein provide, among other things, versatile and convenient methods and systems for animal euthanasia. An example animal euthanasia system is versatile and convenient by permitting small or large numbers of animals to be euthanized at the same time. Moreover, the example system can accept a variety of animal housing sizes and, in certain embodiments, may reduce processing time by introducing a euthanizing gas into the animal housings directly without mixing. Other features and beneficial aspects of example embodiments of the invention are described below.

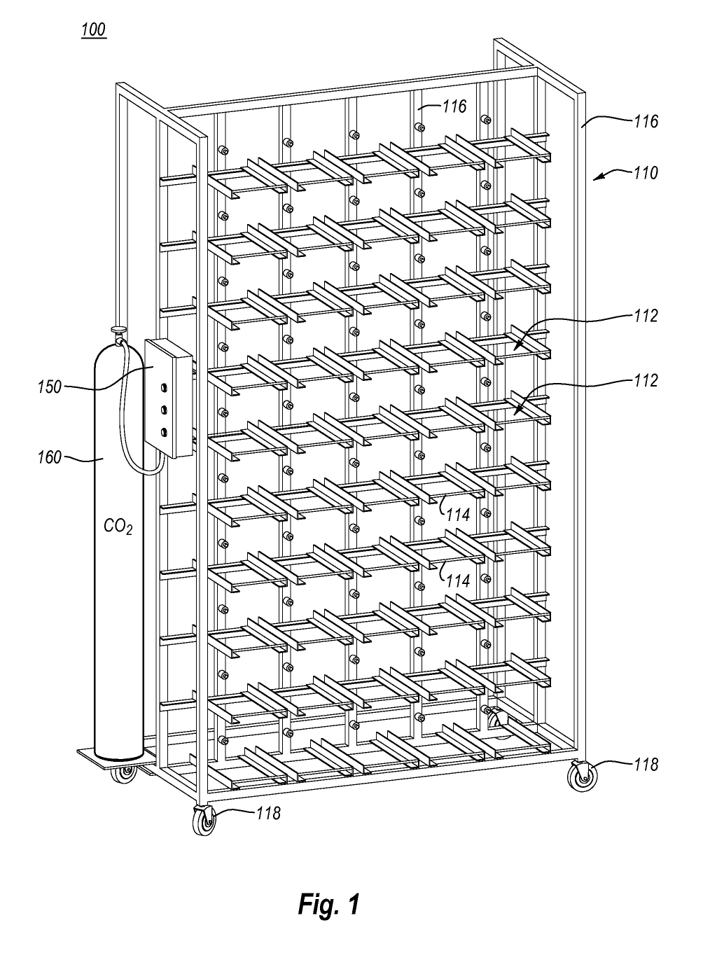

FIG. 1 shows an example animal euthanasia system 100. System 100 includes a rack 110 having a plurality of stations 112 configured to accommodate a plurality of animal housings (not shown). Rack 110 also includes a plurality of retaining bars 114, each configured to maintain the position of a corresponding animal housing in its corresponding station 112. A framing structure 116 of rack 110 may be formed of various components made of any suitable material, such as plastic and/or metal. In one embodiment, framing structure 116 is formed with stainless steel struts, beams, supports, etc. that are joined together, e.g., by welded and/or bolted joints. Moreover, a plurality of wheels 118 may support framing structure 116 to provide mobility.

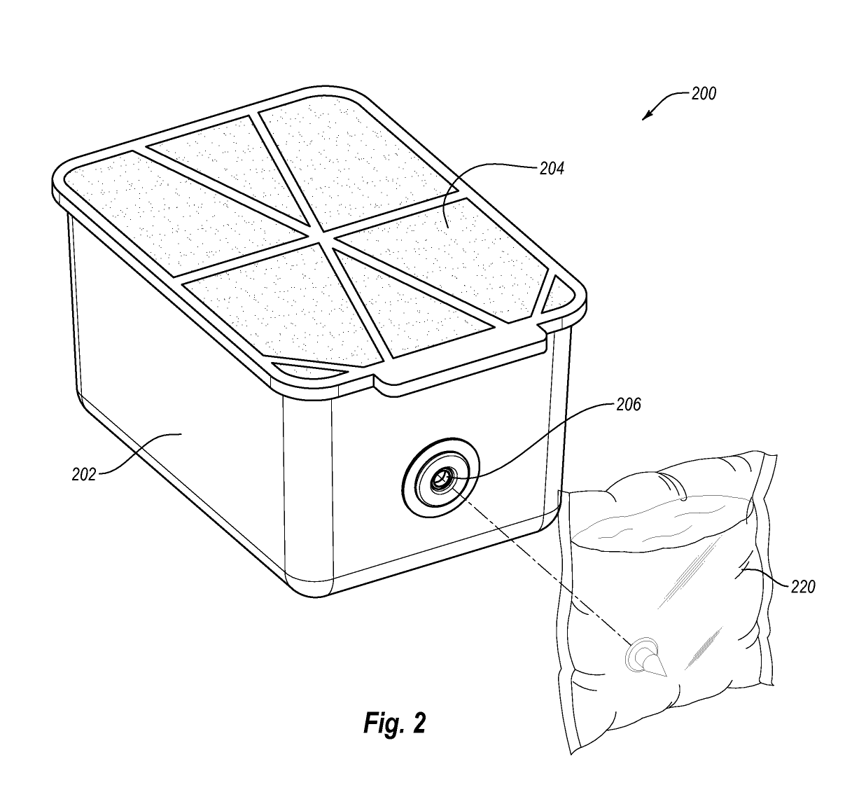

Stations 112 in rack 110 may be sized and configured to accommodate animal housings. An example animal housing is depicted in FIGS. 2 and 3. Moreover, rack 110 may be operable to carry out euthanization while fewer than all, including only one, of the stations 112 are occupied by housings. Stations 112 may be arranged in various ways in rack 110, including an array of rows and columns (as shown), or in a single row or a single column. Moreover, stations may be arranged on only a first, front side of rack 110 (as shown) or on both front and rear sides of rack 110.

System 100 may also include a controller box 150 and a euthanizing gas supply 160. Controller box 150 may include an operator interface including, e.g., start and stop buttons to start and stop a euthanization process. For example, when a start button is pressed, a controller within controller box 150 may cause an electronically actuated main valve within controller box 150 to open to permit passage of the euthanizing gas from euthanizing gas supply 160 into supply lines that are in fluid communication with individual gas valves (not shown) at each station 112. The controller within controller box 150 may be programmed and/or designed to control the main valve to periodically open and close according to a predetermined schedule, thereby releasing the euthanizing gas in a controlled fashion that optimally reduces suffering of the animals undergoing euthanization.

In one example embodiment, framing structure 116 includes hollow structural elements that convey the euthanizing gas to each station 112. Thus, in this example embodiment, framing structure 116 provides a dual function of 1) physically supporting the plurality of animal housings and 2) conveying pressurized euthanizing gas from euthanizing gas supply 160 to a gas valve (not shown) at each station 112.

FIG. 2 shows an exterior view of an example embodiment of animal housing 200 and a liquid supply that interfaces with animal housing 200 during a non-euthanasia phase of operation. During the non-euthanasia phase of operation, housing 200 is equipped to provide shelter, and other life sustaining elements, such as food and/or water, to one or more animals housed therein. A partial enclosure 202 of housing 200 has lateral walls and a floor and may be formed of a transparent, durable material, such as glass, plastic, or the like. Housing 200 also includes a removable lid 204 and an opening 206.

Lid 204 interfaces with partial enclosure 202 to form a complete enclosure. Lid 204 may be formed of a permeable material or may include perforations to permit passage of air into animal housing. In one embodiment, lid 204 includes a filter that prevents passage of contaminants in the environment surrounding animal housing 200 from entering the living environment of the animal(s) within housing 200.

Opening 206 may be formed in a sidewall of partial enclosure 202 to allow passage of a tube or valve that supplies a liquid, such as water, to the animal(s) in housing 200 from a liquid source 220. Opening 206 may be circular in shape, but is not limited to being circular. If a valve is used to supply water through opening 206, the valve may be activated by the animal licking a nipple portion of the valve.

FIG. 3 shows an interior view of the example embodiment of housing 200 in FIG. 2 with lid 204 removed. A hinged door 302 on the interior of housing 200 is positioned over opening 206 and is biased, e.g., by a spring, in a closed position so as to cover opening 206. Consequently, animal(s) in housing 200 are unable to escape through opening 206. On the other hand, a valve or tube 304 (hereafter referred to for brevity as a “feeding valve”) that supplies water to housing 200 may press against door 302, causing it to open. Moreover, opening 206 may be shaped and sized to accommodate feeding valve 304. The interface between opening 206 and feeding valve 304 may be an interference fit (i.e., press-fit) mating interface or a threaded mating interface and may be substantially air-tight to prevent entry of air from the surrounding environment into housing 200. If passage of air into or out of housing 200 is not a concern, the interface between opening 206 and feeding valve 304 may at least be tight enough to prevent escape of the animal(s) in housing 200.

In one example embodiment, housing 200 is configured to house small rodents including, for example, rats and/or mice. In this example embodiment, housing 200 may be a rectangular housing about 15 cm in depth, about 20 cm in width, and about 30 cm in length.

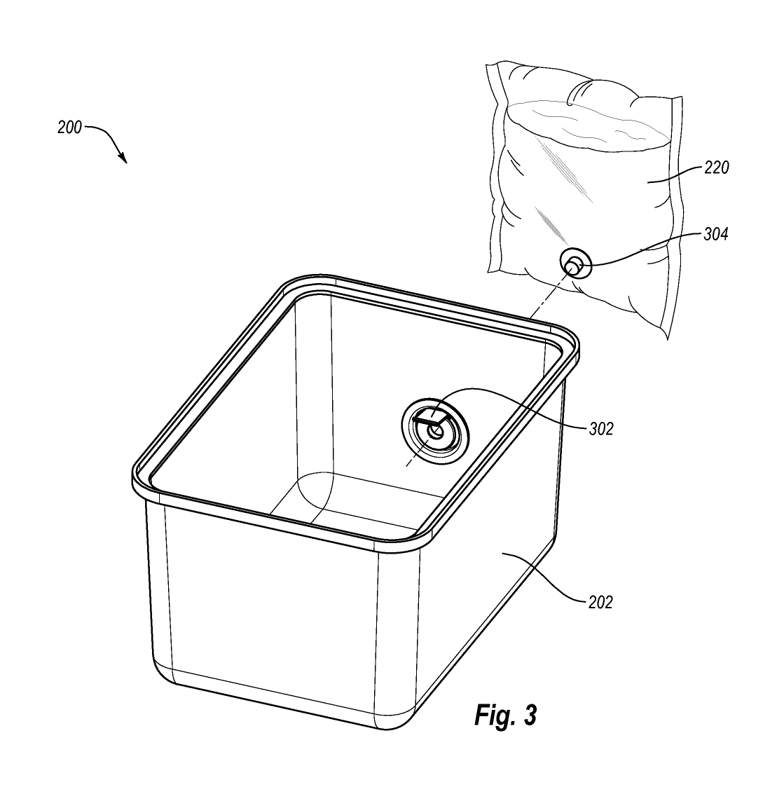

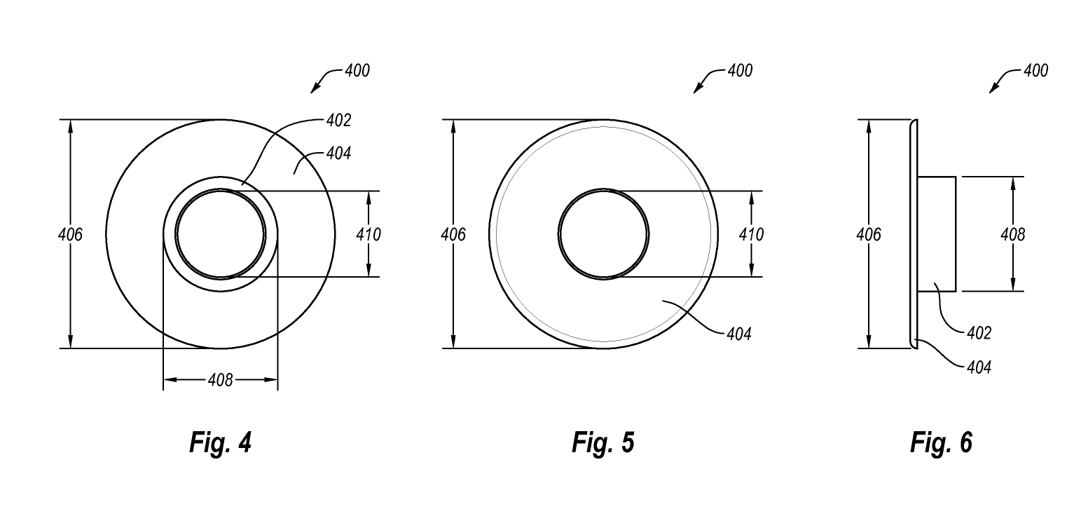

FIGS. 4-6 show front, back, and side views, respectively, of a door opener 400 that may be used to hold door 302 open, among other things. Due to variations in valve sizes and configurations, feeding valve 304 may not be long enough or sturdy enough to keep door 302 open. Thus, door opener 400 may be used to hold door 302 open to allow access to feeding valve 304 by the animal(s) in housing 200.

Door opener 400 may be, for example, a grommet insert including a hollow tube-shaped insert portion 402 sized and configured to fit into a grommet of opening 206 in a press-fit interface. Door opener 400 may also include a circular collar portion 404 sized and configured to hold door 302 open when insert portion 402 is inserted into opening 206. More specifically, a diameter 406 of collar portion 404 may be sized to keep door 302 sufficiently open to allow access to feeding valve 304 and an outer diameter 408 of insert portion 402 may be sized to fit within opening 206. Moreover, if an air-tight interface is desired and feeding valve 304 is not large enough to completely fill opening 206, door opener 400 may be shaped and configured to aid in providing an air-tight interface between opening 206 and feeding valve 304. For example, outer diameter 408 of insert portion 402 may correspond to an inner diameter of opening 206 to form a press fit with opening 206 when inserted therein and an inner diameter 410 of insert portion 402 may correspond to an outer diameter of feeding valve 304 to form a press fit with feeding valve 304 when feeding valve 304 is inserted into insert portion 402. In one example embodiment, a diameter of opening 206 in housing 200 is about 1.3 cm and, therefore, outer diameter 408 of insert portion 402 of door opener 400 is also about or slightly less than 1.3 cm. Moreover, in this example embodiment, diameter 406 of collar portion 404 of door opener 400 is about 2.5 cm and inner diameter 410 of insert portion 402 of door opener 400 is about 1 cm.

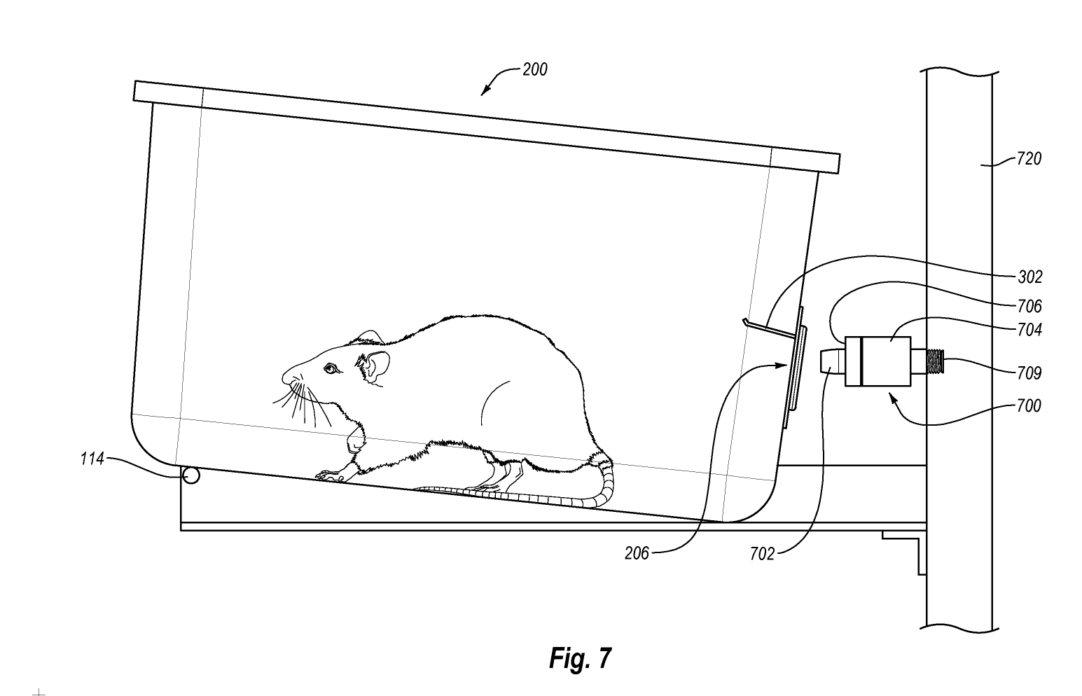

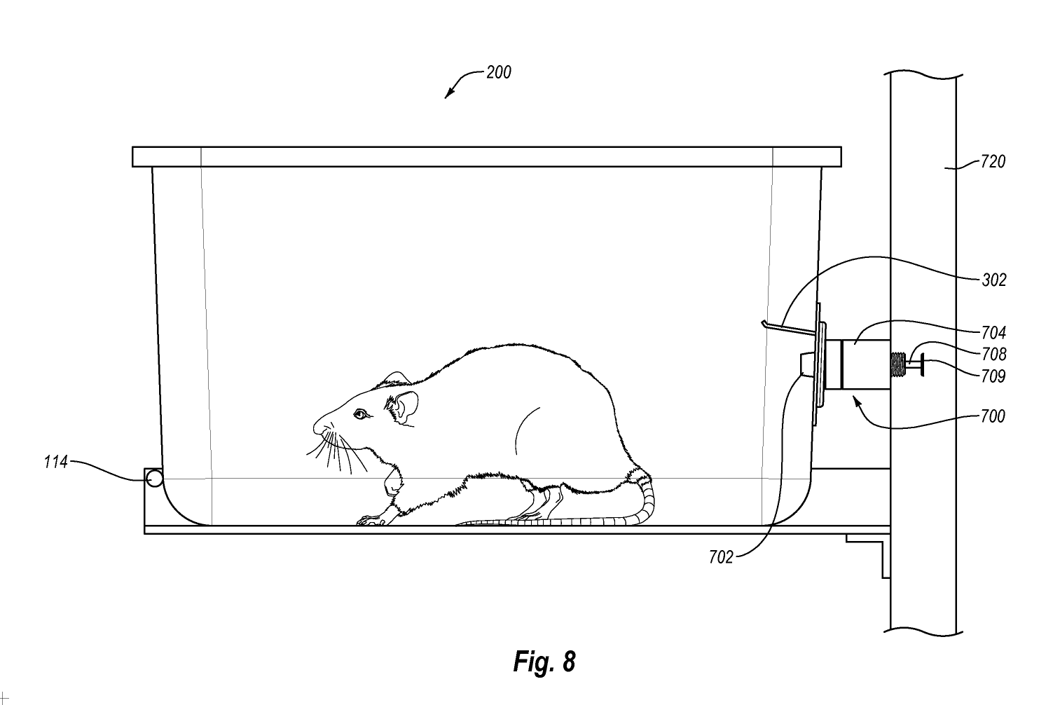

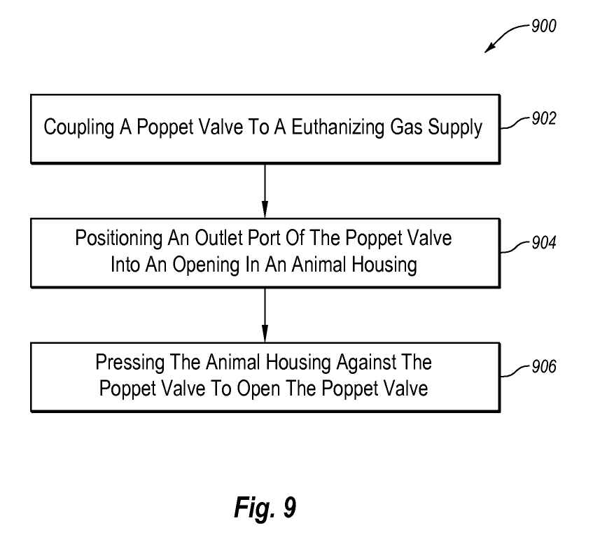

FIGS. 7 and 8 depict two positions of housing 200 during a euthanasia phase of operation. In FIG. 7, housing 200 is partially inserted, e.g., by an operator, into a corresponding one of stations 112 and, in FIG. 8, housing 200 is fully inserted into station 112. At each station 112, a gas valve 700, described in more detail with reference to FIG. 9, protrudes from a gas supply channel 720. Gas supply channel 720 is in fluid communication with euthanizing gas supply 160 and conveys or is part of a network of similar channels that convey the euthanizing gas from supply 720 to each gas valve 700 in each station 112 of rack 110. Gas valve 700 may be joined to supply channel 720 by a threaded joint or other suitable air-tight joint.

Gas valve 700 includes a nose portion 702 that is sized and configured to fit within opening 206 so as to protrude at least partially into housing 200, as shown in FIG. 8. Nose portion 702 of gas valve 700 may be small enough to fit through inner diameter 410 of door opener 400. However, door opener 400 may optionally be omitted, at least during the euthanasia phase of operation, and, therefore, in certain embodiments of gas valve 700 nose portion 702 may be larger than inner diameter 410 of door opener 400 yet small enough to fit through opening 206 of housing 200. Gas valve 700 may also include a body portion 704 having a shoulder 706 that at least partially surrounds nose portion 702. Shoulder 706 and a portion of housing 200 that surrounds opening 206 abut each other when housing 200 is inserted into station 112, as shown in FIG. 8.

In one embodiment, gas valve 700 is a poppet valve that is biased to be closed and opens in response to pressure being applied to shoulder 706. In FIG. 7, gas valve 700 is in its normal, closed state and, in FIG. 8, gas valve 700 is in an open state. In its closed state in FIG. 7, gas valve 700 emits little or no euthanizing gas, whereas in its open state in FIG. 8, gas valve 700 opens to increase an amount of euthanizing gas supplied to housing 200. Therefore, gas valve 700 may be said to automatically open in response to at least a portion thereof being passed through opening 206.

For example, a stem 708 and plug 709 of gas valve 700 are mechanically coupled to body portion 702 and are biased, e.g., by one or more internal springs (not shown), such that plug 709 substantially covers an opening in gas valve 700. The opening covered by plug 709 is in fluid communication with nose portion 702 of gas valve 700. When pressure is applied to shoulder 706 of body portion 702, body portion 702 slides closer toward supply channel 720 and, as a result, stem 708 and plug 709, being mechanically coupled to body portion 702, move at least partially into supply channel 720, as depicted in FIG. 8, thereby uncovering the opening in gas valve 700. Consequently, pressurized euthanizing gas in supply channel 720 is able to pass through the opening in gas valve 700 that was covered by plug 709, through nose portion 702 of gas valve 700, and into housing 200.

A retaining bar 114, which is integrally part of or otherwise physically attached to rack 110, retains housing 200 in its fully inserted position. Therefore, in its fully inserted position, housing 200 is maintained in a position in which it applies pressure to shoulder 706 of the gas valve 700, causing gas valve 700 to remain in its open state instead of returning to its normal, closed state.

Supply channel 720 may be attached to and physically supported by framing structure 116 of rack 110. Alternatively, supply channel 720 may be an integral element of framing structure 116, such as a hollow steel pipe. In one example embodiment, supply channel 720 has a substantially square or rectangular cross section. However, supply channel 720 may have any suitable shape and structure including, e.g., a circular cross section.

As demonstrated by the foregoing description of gas valve 700, gas valve 700 functions not only as a valve but also as a detector to detect whether station 112 is occupied by housing 200. Therefore, one benefit of implementing gas valve 700 at each station in rack 110 is that a euthanasia process may be safely carried out with fewer than all stations 112 in rack 110 being occupied by housings 200. For example, if a station is unoccupied by a housing, gas valve 700 corresponding to the unoccupied station will remain in its normal, closed state while gas valves 700 at occupied stations will be forced open due to pressure applied by individual housings at each occupied station. Accordingly, euthanizing gas will not be emitted into the surrounding atmosphere by the unoccupied stations during the euthanasia phase of operation.

Moreover, in certain alternative embodiments of the invention, the detection and valve functions of gas valve 700 may be carried out separately by two different components that are communicatively coupled. For example, a detector (implemented, e.g., as a motion sensor or push-button switch) at each station 112 may detect when housing 200 occupies the corresponding station. Gas valve 700 may be an electronically actuated valve, such as a solenoid valve, instead of a poppet valve and may be coupled to receive a signal from the detector when the presence of housing 200 is detected, causing the valve to open.

FIG. 9 shows an example method 900 for euthanizing animals. Method 900 includes using a poppet valve to supply euthanizing gas into a first animal housing. For example, in a first stage 902 of method 900, a poppet valve is coupled to a euthanizing gas supply. The poppet valve may be one of multiple poppet valves coupled to a single euthanizing gas supply in a rack of euthanasia stations, such as rack 110 in FIG. 1. Alternatively, the euthanizing gas supply may be coupled only to a single poppet valve and no other poppet valves. In a second stage 904 of method 900, an outlet port of the poppet valve is positioned into an opening in an animal housing. The animal housing may be embodied as housing 200 having opening 206, as described in connection with FIGS. 1-8 above. Finally, in a third stage 906, the animal housing is pressed against the poppet valve to open the poppet valve. Consequently, euthanizing gas is able to pass from the euthanizing gas supply into the animal housing to euthanize animal(s) housed therein.

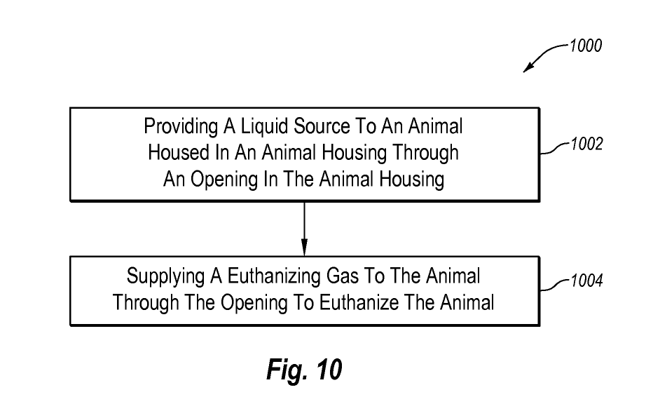

FIG. 10 depicts another example method 1000 for euthanizing animals. First, at stage 1002, a liquid source is provided to an animal housed in an animal housing through an opening in the animal housing. The liquid source may be provided, for example, by passing a feeding valve that is in fluid communication with a liquid supply through the opening. Next, at stage 1004, a euthanizing gas is supplied to the animal through the same opening to euthanize the animal. The euthanizing gas may be supplied, for example, by passing a euthanizing gas valve that is in fluid communication with a euthanizing gas supply through the opening in the animal housing. In stage 1002 the animal housing may be positioned on a rack so that the opening faces outward and is visible and accessible to an operator when providing the liquid source. In stage 1004, during a euthanization phase, the animal housing may be positioned on the same or another rack so that the opening faces inward toward a euthanizing gas valve and is less accessible to the operator.

The foregoing description of methods 900 and 1000 are provided by way of example and not limitation. More specifically, in addition to the various alternatives described above, various other versions of methods 900 and 1000 may be implemented, including versions in which various stages are omitted or added or in which the order of the depicted stages differ. For example, if the animal housing of method 1000 includes a hinged door that covers the opening through which liquid is passed, method 1000 may further include a stage in which a door opener is inserted into the opening to maintain the hinged door in an open configuration prior to providing the liquid source through the opening. Alternatively, the feeding valve and/or a tube in fluid communication with the feeding valve are/is configured to maintain the hinged door in an open configuration. Moreover, although methods 900 and 1000 have been described with respect to a single animal housing, each method may be carried out to euthanize animals in multiple animal housings, either simultaneously or in series.

The foregoing detailed description of various embodiments is provided by way of example and not limitation. Accordingly, the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for euthanizing animals, the system comprising:
a first animal housing having an opening configured to receive euthanizing gas; and
a first valve configured to increase an amount of the euthanizing gas supplied to the first animal housing through the opening in response to the first animal housing being placed in a predetermined position with respect to the first valve.

2. The system of claim 1, wherein the first valve is a poppet valve.

3. The system of claim 2, wherein the poppet valve is configured to increase the amount of euthanizing gas by opening in response to the first animal housing being pressed against the poppet valve.

4. The system of claim 1, wherein a nose portion of the first valve is configured to fit within the opening of the first animal housing.

5. The system of claim 4, wherein a portion of the first animal housing that surrounds the opening is configured to abut a shoulder of the first valve that surrounds the nose portion thereof, the first valve being configured to increase the amount of the euthanizing gas supplied to the first animal housing through the opening in response to pressure applied by the first animal housing to the shoulder of the first valve.

6. The system of claim 1, further comprising a euthanizing gas supply in fluid communication with the first valve.

7. The system of claim 1, further comprising:
a second animal housing having an opening configured to receive euthanizing gas; and
a second valve configured to increase an amount of the euthanizing gas supplied to the second animal housing through the opening of the second animal housing in response to the second animal housing being placed in a predetermined position with respect to the second valve.

8. The system of claim 1, further comprising a rack configured to physically support the first animal housing and to maintain the first animal housing in the predetermined position.

9. A method for euthanizing animals, the method comprising:
providing a liquid source to an animal housed in an animal housing through an opening in the animal housing; and
supplying a euthanizing gas to the animal through the opening to euthanize the animal.

10. The method of claim 9, wherein providing the liquid source includes passing a feeding valve that is in fluid communication with a liquid supply through the opening.

11. The method of claim 9, wherein supplying the euthanizing gas includes passing at least a portion of a euthanizing gas valve that is in fluid communication with a euthanizing gas supply through the opening in the animal housing.

12. The method of claim 11, wherein the euthanizing gas valve automatically opens in response to the at least a portion of the euthanizing gas valve being passed through the opening.

13. The method of claim 9, wherein the animal housing includes a hinged door that covers the opening.

14. The method of claim 13, further comprising inserting a door opener in the opening to maintain the hinged door in an open configuration prior to providing the liquid source through the opening.

15. The method of claim 14, wherein the door opener is shaped and configured to physically support the feeding valve.

16. The method of claim 15, wherein the door opener is configured to mate with the feeding valve in an interference fit and is configured to mate with the opening in an interference fit.

17. The method of claim 13, wherein providing the liquid source includes passing a feeding valve that is in fluid communication with a liquid supply through the opening, and wherein the feeding valve and/or a tube in fluid communication with the feeding valve are/is configured to maintain the hinged door in an open configuration.

18. A system for euthanizing animals, the system comprising:
a rack having a plurality of stations configured to accommodate a plurality of animal housings; and
a plurality of detectors corresponding to the plurality of stations, each detector being configured to detect when the corresponding station is occupied by an animal housing.

19. The system of claim 18, wherein each of the detectors includes a valve configured to supply euthanizing gas to the animal housing accommodated by the corresponding station in response to the detector detecting the animal housing.

20. The system of claim 18, wherein, if fewer than all of the stations are occupied by a corresponding animal housing, the system is configured to supply euthanizing gas to only the stations at which the plurality of detectors detect an animal housing.

21. The system of claim 18, wherein the rack includes a framing structure configured to physically support the plurality of animal housings accommodated at each station, at least a portion of the framing structure being further configured to convey euthanizing gas from a euthanizing gas supply to a valve at each station.

22. The system of claim 21, wherein the detector at each station includes the corresponding valve.

23. A method for euthanizing animals, the method comprising:
using a first poppet valve to supply euthanizing gas into a first animal housing.

24. The method of claim 23, further comprising:
using a second poppet valve to supply euthanizing gas into a second animal housing, the first and second poppet valves being in fluid communication with each other and with a euthanizing gas supply.

25. The method of claim 23, wherein using the first poppet valve to supply euthanizing gas into the first animal housing includes:
coupling the first poppet valve to a euthanizing gas supply;
positioning an outlet port of the first poppet valve into an opening in the first animal housing; and
pressing the first animal housing against the first poppet valve to open the first poppet valve.
